(19) United States
(12) Patent Application Publication
(10) Pub. No.: US 2012/0188173 A1
(43) Pub. Date: Jul. 26, 2012

(54) TOUCH PANEL ASSEMBLY

(76) Inventor: Teh-Zheng Lin, Taoyuan (TW)

(21) Appl. No.: 13/011,933

(22) Filed: Jan. 24, 2011

(51) Int. Cl. G06F 3/041

(52) U.S. Cl. 345/173

(57) ABSTRACT

A touch panel assembly includes a substrate. An upper sensing electrode layer, upper signal conducting layer, and functional layers are formed to an upper surface of the substrate in order. A lower sensing electrode layer, lower signal conducting layer, and functional layers are formed to a lower surface of the substrate in order. The functional layers are one of combination of insulated layer, gluing layer, protection layer, frame layer, cover lens, anti-fingerprint film, nebulizing film, hard coating, polarized thin film, phase shift thin film, or liquid display module. The substrate is a transparent plate or stacking transparent plates made of the same of different materials. The transparent plate is a flat or uneven plate such as a convex or concave plate.

### FIELD OF THE INVENTION

The present invention relates to touch panel, and particular to a touch panel assembly having a sensing circuit and functional films on two surfaces of a single substrate so as to improve a coupling precision of the sensing circuit and optical characteristic especially to manufacture of roll to roll or sheet to sheet.

### DESCRIPTION OF THE PRIOR ART

Touch panels usually includes multiple layers stacking together. Layers of electrode, circuit, and other function are formed to two substrates respectively, and the two substrates are attached together by a gluing layer of transparent optical glue. Referring to FIG. 19, a lower substrate 820 is attached to an electrode layer 850 of an upper substrate 840 by a gluing layer 810, and a cover lens 870 and other functional layers are attached to the upper substrate 840 by a gluing layer 860. A protection layer 880 is attached to the electrode layer 830 of the lower substrate 820. Referring to FIG. 20, an electrode layer 850 of an upper substrate 840 is attached to an electrode layer 830 of a lower substrate 820 by a gluing layer 810, and a cover lens 870 with other functional layers are attached to the upper substrate 840 by a gluing layer 860. Such processes of mass production are complicated and bad alignment could be happened to attachment of the upper and lower electrode layers 850 and 830 which might cause wrong sensing signal and damage to appearance and optical characteristic. Distortion of image could happen because of uneven refraction of lights.

### SUMMARY OF THE PRESENT INVENTION

Accordingly, the primary object of the present invention is to provide a touch panel assembly having the sensing electrode layers, signal conducting layers, and other functional layers arranged to the upper and lower surface of a same substrate so that the coupling between the layers is improved as well as the optical characteristic of the touch panel and the manufacture could be simplified also.

To achieve above object, the present invention includes a substrate. An upper sensing electrode layer, upper signal conducting layer, and functional layers are formed to an upper surface of the substrate in order. A lower sensing electrode layer, lower signal conducting layer, and functional layers are formed to a lower surface of the substrate in order. The alignment between the layers is good by forming the sensing electrode layers, signal conducting layers, and functional layers being to the upper and lower surfaces of the same substrate. The substrate is a thin transparent flat or uneven plate made of glass, polycarbonate (PC), polyester (PET), polymethyl methacrylate (PMMA), Cyclo-Olefin Copolymers (COC), or other materials such as any soft, hard, transparent, or semi-transparent material. Moreover, the substrate is a transparent plate or stacking transparent plates made of the same of different material.

The sensing electrode layers are Indium Tin Oxide or Indium-Zinc Oxide films. The signal conducting layers are signal conducting wires of Mo/Al/Mo or Ag/Pu/Cu coating formed by photo process. The functional layers includes insulated layer, gluing layer, protection layer, frame layer, cover lens, anti-fingerprint film, nebulizing film, hard coating, polarized thin film, phase shift thin film, liquid display module, or other functional layers.

### BRIEF DESCRIPTION OF THE DRAWINGS

FIG. 1 is a cross-section view of the first embodiment of the present invention.

FIG. 2 is a cross-section view of the second embodiment of the present invention.

FIG. 3 is a cross-section view of the third embodiment of the present invention.

FIG. 4 is a cross-section view of the fourth embodiment of the present invention.

FIG. 5 is a cross-section view of the fifth embodiment of the present invention.

FIG. 6 is a cross-section view of the sixth embodiment of the present invention.

FIG. 7 is a cross-section view of the seventh embodiment of the present invention.

FIG. 8 is a cross-section view of the eighth embodiment of the present invention.

FIG. 9 is a cross-section view of the ninth embodiment of the present invention.

FIG. 10 is a cross-section view of the first embodiment of the present invention with stacking plates of the substrate.

FIG. 11 is a cross-section view of the second embodiment of the present invention with stacking plates of the substrate.

FIG. 12 is a cross-section view of the third embodiment of the present invention with stacking plates of the substrate.

FIG. 13 is a cross-section view of the fourth embodiment of the present invention with stacking plates of the substrate.

FIG. 14 is a cross-section view of the fifth embodiment of the present invention with stacking plates of the substrate.

FIG. 15 is a cross-section view of the sixth embodiment of the present invention with stacking plates of the substrate.

FIG. 16 is a cross-section view of the seventh embodiment of the present invention with stacking plates of the substrate.

FIG. 17 is a cross-section view of the eighth embodiment of the present invention with stacking plates of the substrate.

FIG. 18 is a cross-section view of the ninth embodiment of the present invention with stacking plates of the substrate.

FIG. 19 is a schematic view showing a prior touch panel assembly; and

FIG. 20 is a cross-section view showing components of a prior touch panel assembly.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

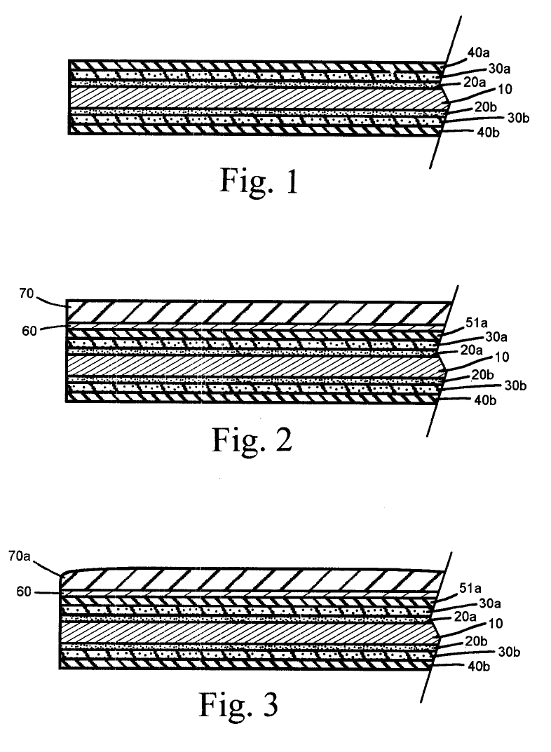

Referring to FIG. 1, the first embodiment of a touch panel assembly according to the present invention has a transparent substrate 10. An upper sensing electrode layer 20a, upper signal conducting layer 30a, and an upper protection layer 40a are formed upon an upper surface of the substrate 10 in order. A lower sensing electrode layer 20b, lower signal conducting layer 30b, and a lower protection layer 40b are formed to a lower surface of the substrate 10 in order. The processes of each layer are based on a same positioning target (not shown) for precisely aligning the layers so as to improve the yield and optical characteristic. The positioning target can be a hole, cave, or any other positioning mark.

The transparent substrate 10 is made of glass, polycarbonate, polyester, polymethyl methacrylate, Cyclo-Olefin Copolymers, or other material such as any soft, hard, transparent, or semi-transparent material. The upper and lower sensing electrode layers 20a and 20b are Indium Tin Oxide or Indium-Zinc Oxide films. X axis sensing traces and Y axis sensing traces are formed to the upper and lower sensing electrode layers respectively. The upper and lower signal conducting layer 30a, 30b are signal conducting wires of Mo/Al/Mo or Ag/Pu/Cu coating formed by photo process. The signal conducting wires of the signal conducting layers 30a and 30b are connected to the sensing electrode layers. The upper and lower protection layers 40a, 40b are made of Silicon Nitride, Silicon Dioxide, photoresist, or a solidified material such as UV optical adhesive, or transparent thin plate of glass, polycarbonate, or polyester. The upper protection layers 40a is formed above the upper sensing electrode layers 20a and the upper signal conducting layer 30a so as to protect the layers from being damaged, and the lower protection layers 40b is formed above the sensing electrode layers 20b and the signal conducting layer 30b so as to protect the layers from being damaged.

Moreover, a second embodiment of the present invention having the same components as the first embodiment further includes a gluing layer 51a covering over the signal conducting layer 30a for attaching a color frame 60 (I-Con) and a cover lens 70. The color frame 60 formed to a bottom edge of the cover lens 70 is made of ink, color photo resistance, organic material, or inorganic material by means of printing, coating, or metal evaporation coating. The material and method are not limited to those which are mentioned above. The opaque color frame 60 having a thickness of 0.5˜15 μm will cover the upper and lower signal conducting layers so as to have a better appearance.

A third embodiment of the present invention is illustrated in FIG. 3. The embodiment has a convex cover lens 70a instead of the flat cover lens 70 of the second embodiment. The uneven cover lens could be a concave or combination of convex and concave surfaces arranged regularly or irregularly.

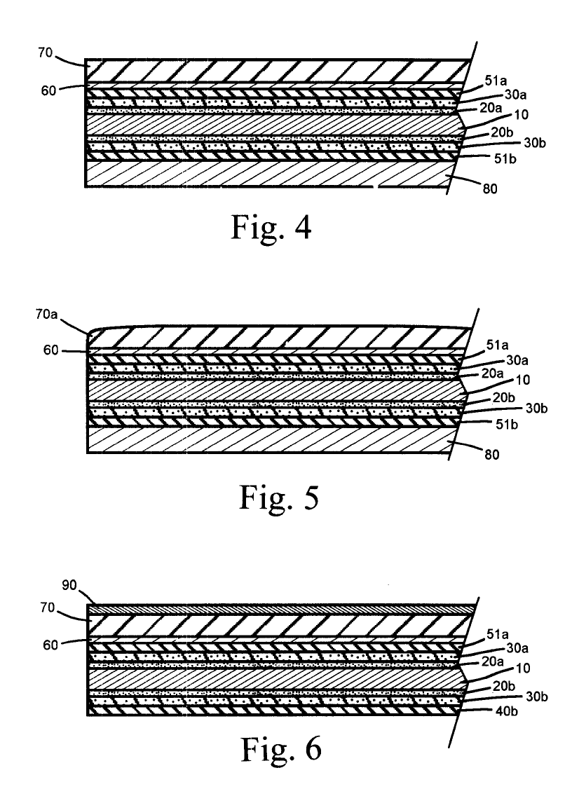

The fourth embodiment based on the second embodiment of the present invention further has a gluing layer 51b arranged to a lower surface of the lower signal conducting layer 30b for attaching a Liquid Crystal Display Module (LCM) 80 as shown in FIG. 4. A fifth embodiment based on the third embodiment of the present invention further has a gluing layer 51b arranged to a lower surface of the lower signal conducting layer 30b for attaching a Liquid Crystal Display Module (LCM) 80 as shown in FIG. 5.

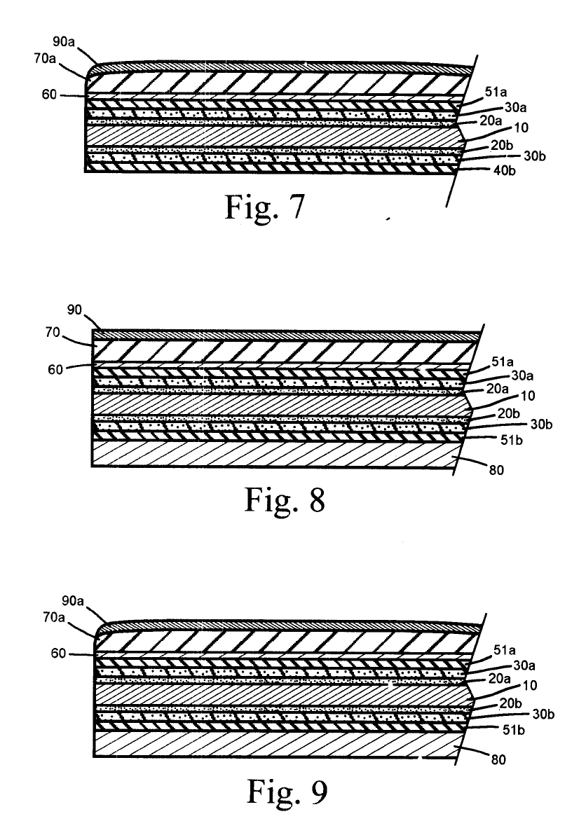

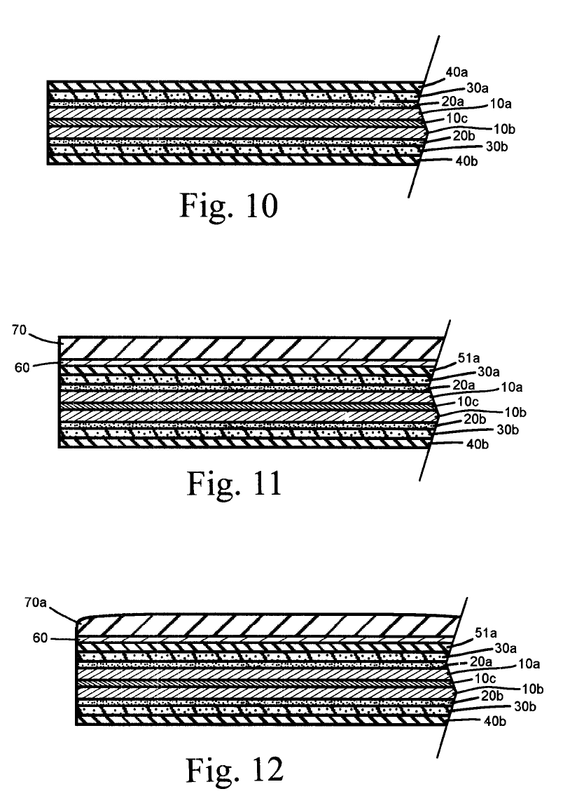

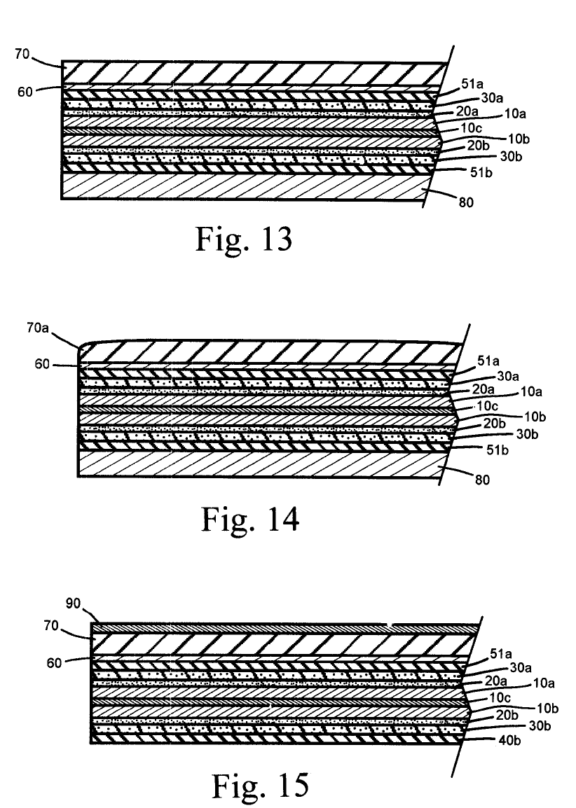

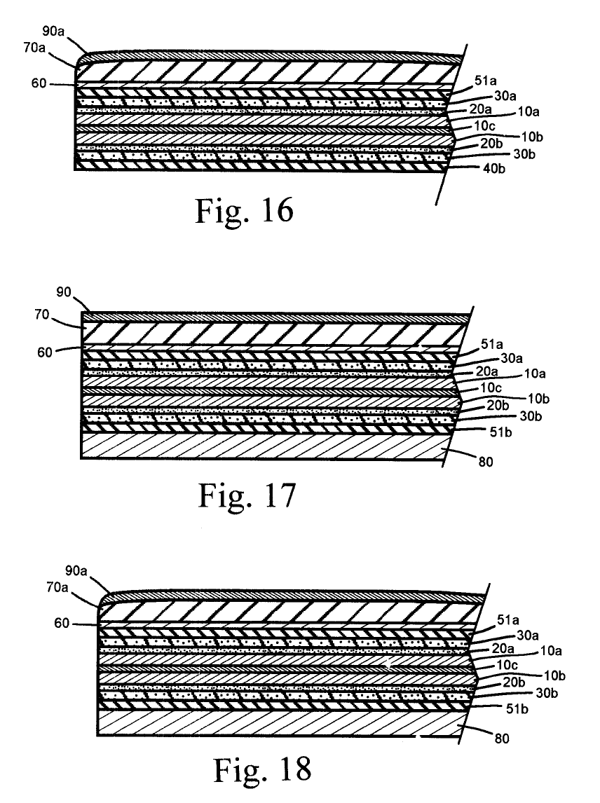

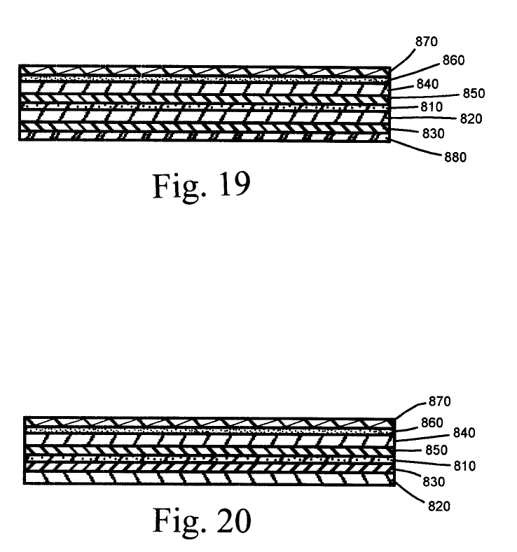

Referring to FIG. 6. the sixth embodiment based on the second embodiment of the present invention has a functional film 90 attached to the flat cover lens 70. The seventh embodiment based on the third embodiment of the present invention has a convex functional film 90a attached to the convex cover lens 70a as shown in FIG. 7. The eighth embodiment based on the fourth embodiment of the present invention has a functional film 90 attached to the flat cover lens 70 as shown in FIG. 8. The ninth embodiment based on the fifth embodiment of the present invention has a functional convex film 90a attached to the convex cover lens 70a as shown in FIG. 9. The functional film 90 or 90a can be an anti-fingerprint film, nebulizing film, or hard coating to avoid dust, lower the reflective index of the panel, or to improve the hardness against scratching and rubbing. The functional film 90 or 90a can also be a light regulating film 80 made of one or combination of a polarized thin film, phase shift thin film, or an optical isotropic film for improving the visibility of the display.

The present invention is thus described, it will be obvious that the same may be varied in many ways. For example, the transparent substrate 10 could be replaced by stacking plates of transparent substrate 10a and 10b glued by a gluing layer 10c as shown in FIG. 11. The transparent plates 10a and 10b can be made of the same or different material. Such variations having equivalent function with the above embodiments are not to be regarded as a departure from the spirit and scope of the present invention, and all such modifications as would be obvious to one skilled in the art are intended to be included within the scope of the following claims.

What is claimed is:

1. A touch panel assembly comprising a substrate having an upper sensing electrode layer, upper signal conducting layer, and functional films orderly formed to an upper surface of the substrate; and a lower sensing electrode layer, lower signal conducting layer, functional films orderly formed to a lower surface of the substrate; the sensing electrode layers, signal conducting layers, and functional films being formed to the upper and lower surfaces of the same substrate; the functional films being one or combination of insulated layer, gluing layer, protection layer, frame layer, cover lens, anti-fingerprint film, nebulizing film, hard coating, polarized thin film, phase shift thin film, or liquid display module.

2. The touch panel assembly as claimed in claim 1, wherein the substrate is one of a transparent plate or transparent stacking plates.

3. The touch panel assembly as claimed in claim 2, wherein the stacking plates are made of the same or different materials.

4. The touch panel assembly as claimed in claim 2, wherein the transparent plate is one of a flat plate or uneven plate such as a convex plate or a concave plate.

5. The touch panel assembly as claimed in claim 2, wherein the transparent substrate is made of one of glass, polycarbonate, polyester, polymethyl methacrylate, or Cyclo-Olefin Copolymers.

6. The touch panel assembly as claimed in claim 1, wherein the cover lens is one of a flat plate or uneven plate such as a convex plate or a concave plate.
